(19) United States
(12) Patent Application Publication
(10) Pub. No.: US 2010/0025981 A1
(43) Pub. Date: Feb. 4, 2010

(54) SYSTEM AND METHOD FOR CHARACTERIZING A BEVERAGE

(76) Inventors: Thierry LAY, Boulogne-Billancourt (FR); Jean-Etienne Durand, Sanvignes-les-Mines (FR); Karl-Frederic Reuter, Rennes (FR)

Correspondence Address: MCCORMICK, PAULDING & HUBER LLP, CITY PLACE II, 185 ASYLUM STREET, HARTFORD, CT, 06103, US

(21) Appl. No.: 12/184,625

(22) Filed: Aug. 1, 2008

(51) Int. Cl. B42D 15/00; G09B 29/00; G06T 11/20

(52) U.S. Cl. 283/115; 345/440

(57) ABSTRACT

A graphic indicator of olfactory and gustatory characteristics of a beverage. The indicator includes a background portion having a first color. The indicator further includes a plurality of contiguous segments on the background portion. Each segment represents a separate characteristic of the beverage, and each segment is divided into separate strength zones. The strength zones can be darkened in a color other than the first color to indicate a strength level of a characteristic of the beverage to provide a graphic representation of the beverage to enable consumers can make an informed purchasing decision.

### FIELD OF THE INVENTION

The present invention relates generally to a system and method for characterizing a beverage and more specifically to a system and method for providing consumers with graphic, intuitive information about the olfactory and gustatory characteristics of wine.

### BACKGROUND OF THE INVENTION

Selecting wine can often be a daunting and difficult task, as consumers typically do not have sufficient information regarding a wine's characteristics to make an informed purchasing decision. In many retail settings, consumers are presented with a huge selection of wines and wine sales are poorly supported with very few trained sales people. Moreover, many consumers are reluctant to obtain information in the face of uncertainty.

European wines present additional difficulties for consumers, particularly those in the United States, as they are characterized based on “terroir” as opposed to grape varietal. As such, consumers used to purchasing wines classified by varietal, e.g., Merlot, Cabernet-Sauvignon and Chardonnay, can be confused when presented with wines classified by geographic region without reference to the type of grape. Moreover, information contained on labels on many European wines, particularly French wines, can be difficult to understand. This difficulty is due not only to the type of information, but also the language in which it is presented and how labels are formatted.

Given these difficulties, consumers often have difficulty selecting a wine. The lack of useful information regarding a wine's characteristics often results in uninformed purchasing decisions many of which are made based on price.

With the foregoing issues in mind, it is a general object of the present invention to provide a method and system for characterizing wine employing criteria sufficient to make an informed purchasing decision taking into account a purchaser's preferences. The method and system presents such information graphically such that it can be universally understood regardless of language.

### SUMMARY OF THE INVENTION

It is an object of the present invention to provide a system and method for characterizing and selecting a beverage.

It is an object of the present invention to provide a system and method for characterizing and selecting wine.

It is another object of the present invention to provide a system and method for characterizing and selecting wine in which consumers are presented with information sufficient to make an informed wine purchase.

It is yet another object of the present invention to provide a system and method for characterizing and selecting wine in which consumers are presented with information sufficient to make an informed wine purchase employing criteria that take into account consumers' personal preferences.

It is an object of the present invention to provide a system and method for characterizing and selecting wine in which consumers are presented with information sufficient to make an informed wine purchase including individual criteria and the intensity or strength of each criteria.

It is an additional object of the present invention to provide a system and method for characterizing and selecting wine in which consumers are presented with information that is easily comprehensible regardless of language.

It is an additional object of the present invention to provide a system and method for characterizing and selecting wine in which consumers are presented with information that is easily comprehensible where the information is presented graphically.

An embodiment of the present invention is a visual indicator of olfactory and gustatory characteristics of a food or beverage. The indicator includes a background portion having a first color. The indicator further includes a plurality of contiguous segments on the background portion. Each segment represents a separate characteristic of the food or beverage, and each segment is divided into separate strength zones. The strength zones can be darkened in a color other than the first color to indicate a strength level of a characteristic of the food or beverage to provide a graphic representation of the food or beverage to enable consumers can make an informed purchasing decision

### BRIEF DESCRIPTION OF THE DRAWINGS

FIG. 1 is a schematic diagram illustrating a system in accordance with an embodiment of the present invention.

FIG. 2 is a simplified wine graph in accordance with an embodiment of the present invention depicted scale.

FIG. 3 is the wine graph of FIG. 1 depicting specific criteria and a strength scale for each criteria.

FIGS. 3a-3c are alternate configurations of the wine graph of FIG. 3 depicting different color schemes.

FIG. 4 is flowchart illustrating steps of creating a wine graph as accomplished by the system of FIG. 1.

FIG. 5 is screen capture of a graphic user interface of the system of FIG. 1.

FIG. 6 is a simplified schematic diagram illustrating an expert system in accordance with an embodiment of the present invention.

### DETAILED DESCRIPTION OF THE PREFERRED EMBODIMENT

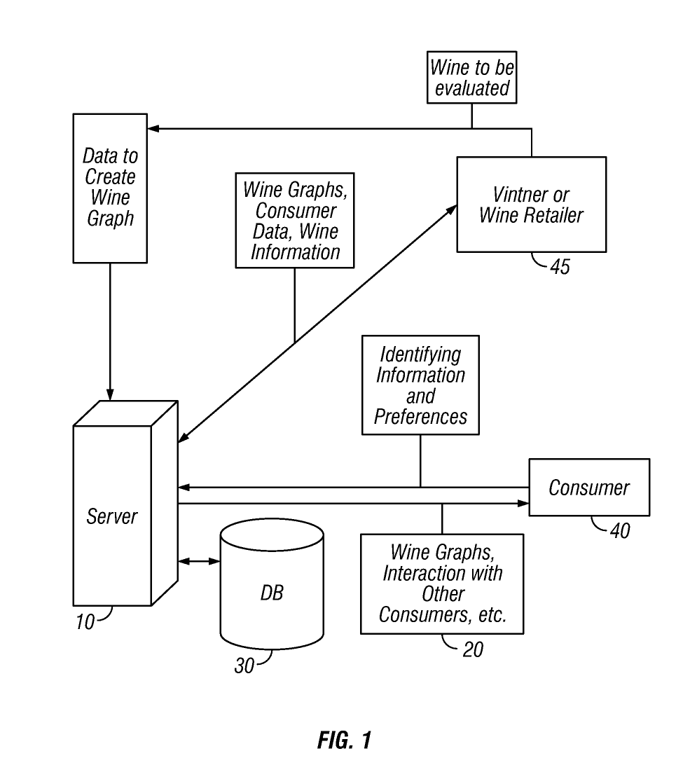

FIG. 1 is a simplified schematic of the components of the inventive system. In general, the system creates intuitive, comprehensive graphs that are representative of individual wines and stores for access by consumers. The system employs software residing on a server with a processor 10 to create the inventive wine graphs 20 and store them in a database 30 operatively connected to the processor 10. Moreover, the system is accessible by consumers 40, i.e., “users,” via the Web through a graphical user interface (GUI), which allows consumers to enter and store identifying information and wine preferences to create their own individualized graphs representative of their personal preferences. Consumers may also obtain existing wine graphs stored in the database 30. Additionally, as discussed greater detail herein, a consumer's personalized graphs may be compared to wine graphs to create individualized matches.

It is also contemplated that wine retailers and vintners 45 can access the database 30 to obtain wine graphs for their use such as creating point of sale displays. The system may be accessed on a subscription basis with both consumers and/or wineries being able to subscribe, access and/or generate wine graphs.

As will be appreciated, the inventive wine graphs are an important aspect of the present invention. The inventive graphs use several relevant descriptive criteria to create intuitive graphical representations of a wine. Consumers can use these graphs to make informed decisions to purchase a wine. The inventive graphs are easy to understand and provide useful information in a manner previously unknown in the art.

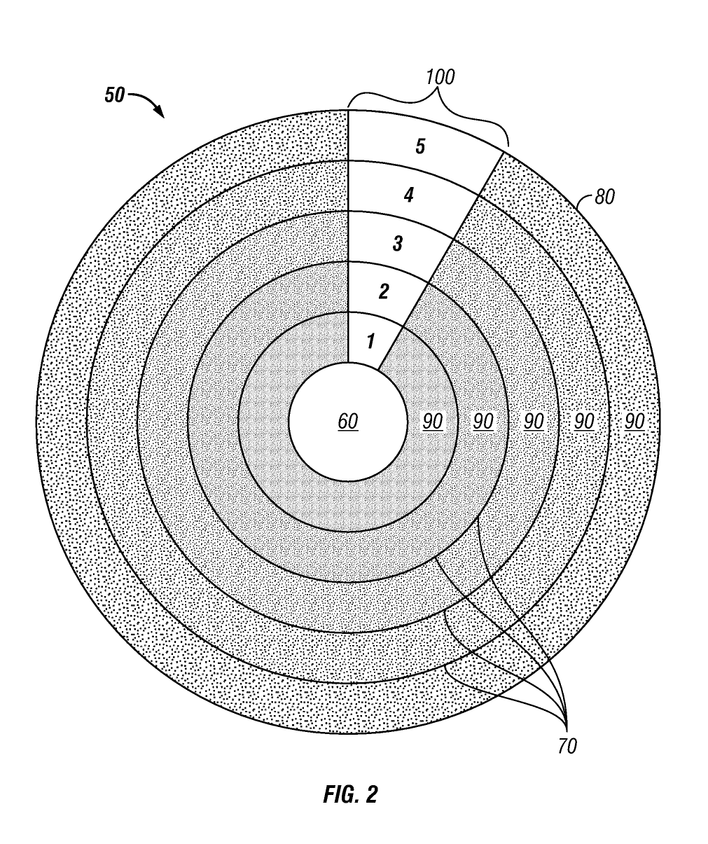

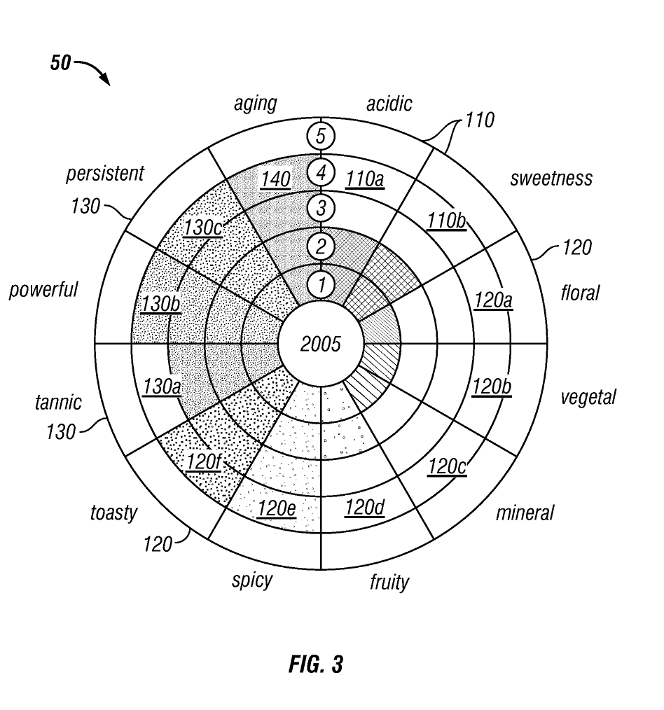

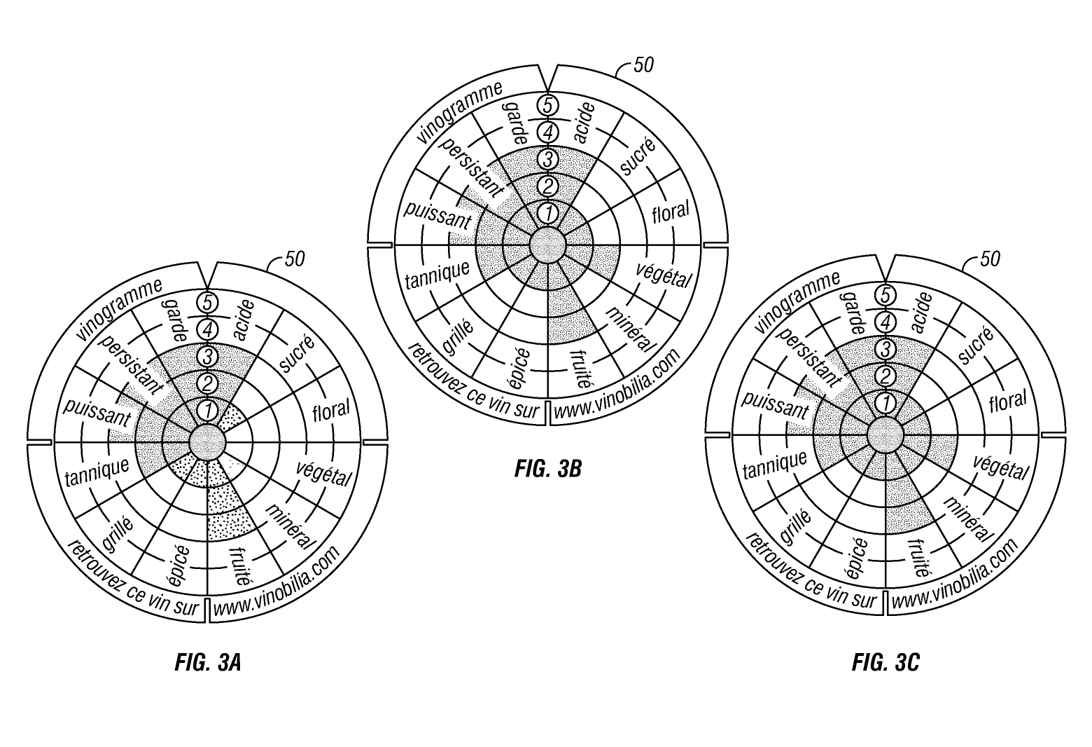

Referring now to FIGS. 2 and 3, the graph 50 is a circle graph or pie chart with a “bulls-eye” center section 60. The center section 60 preferably contains identifying information about the wine, such as its name and/or vintage. The inventive graph 50 also features a series of progressively smaller concentric circles or delineations 70 within the main or outer circle 80. Preferably, there are four smaller concentric circles 70 within the main or outer circle 80 creating spaces or zones 90 between each circle 70. These spaces represent strength or intensity values such that each graph is divided into five circular strength bands or zones 90.

Further, the graph is divided into twelve criteria, each of which are represented by a sector 100 of the circle. Each sector 100 has a central angle of thirty degrees. As will be appreciated, should the number of sectors 100 be reduced the central angle of each sector will increase. As depicted, each of the sectors 100 has five strength zones 90 created by the concentric circles 70. The zones are another important aspect of the present invention as they allow the strength or intensity of a particular criteria or descriptor to be graphically depicted.

Turning now to FIG. 3, the twelve criteria fall into one of four general groups: taste 110, aroma 120, structure 130, and aging potential 140. These four groups, in addition to price, provide a comprehensive, detailed overview of a wine sufficient to facilitate an informed purchase.

The four groups 110, 120, 130, 140 are divided into twelve specific criteria. More specifically, the taste group 110 is divided into acidity 110a and sweetness 100b (from dry to sweet). Aroma 120 is divided into floral 120a, vegetal 120b, mineral 120c, fruity 120d, spicy 120e and toasty 120f and the structure group 130 is separated into tannic 130a, powerful 130b (weak to strong), and persistent 130c (length of taste in mouth). Finally, aging potential 140 is not subdivided and remains a group unto itself. As will be appreciated, some of the aforementioned criteria may be omitted or other criteria may be added. It is believed, however, that the twelve criteria present consumers with an ideal amount of information on the most significant qualities of wine. This information may be quickly employed by a consumer to make a purchase.

Preferably, the twelve criteria are organized by group 110, 120, 130, 140 with the categories within each of the four groups being adjacent to one another on the graph 50. Further, each group 110, 120, 130, 140 has a different color set with, for example, the criteria within aroma group 120 being different shades of yellow and the criteria within the taste group 130 being different shades of green. The background color of the chart is preferably neutral such as gray or white. While different colors may be utilized, grouping by color makes the inventive chart easy to comprehend and intuitive.

As stated, each of the twelve criteria has a strength ranging from 1-5. Preferably, the smallest value (1) is the strength zone closest to the center of the circle, i.e., the bulls-eye, and the highest value (5) is the strength zone most distant from the center. For example, if a wine is very tannic, all five strength zones in the tannic sector 130a will be darkened in the color that is assigned to the tannic criteria. If a wine is ready to drink now and is not age worthy, then only the first strength zone on the aging potential sector 140 will be darkened. If the strength zone is not darkened, it will be the background color of the chart 50. This color scheme provides an intuitive, graphic representation of the criteria.

As will be appreciated, other color schemes may be employed. Other schemes may include those with a single color or black and white/grayscale, two colors or four colors as long as they effectively convey information regarding the wine. In particular, fewer colors may be used as long as the color(s) of the segments is different from the background color. Other color schemes are depicted in FIGS. 3a-3c with FIG. 3a showing a four color graph, FIG. 3b a two color graph and FIG. 3c, a one color grayscale or black and white graph.

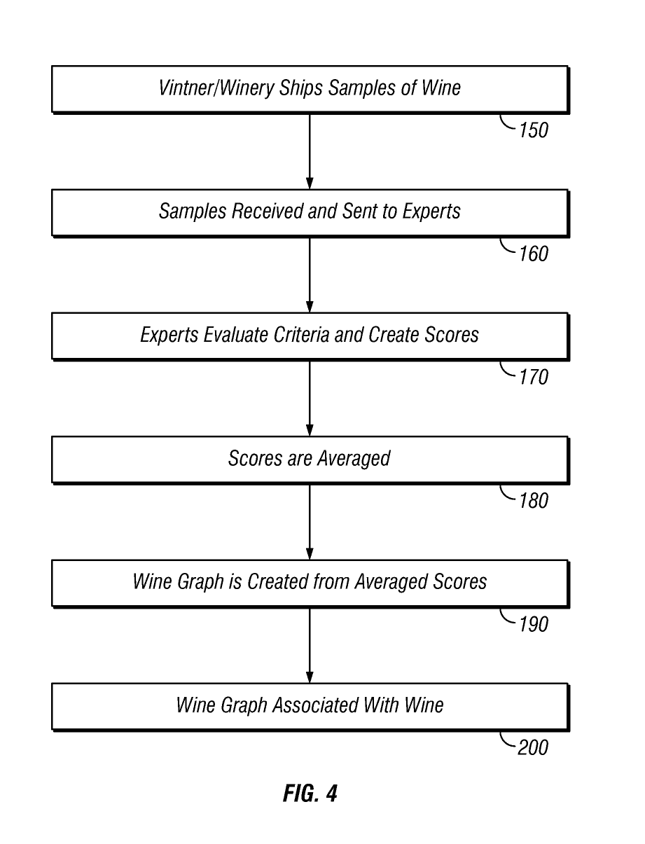

Turning now to FIG. 4, each wine graph 50 is created by a panel of wine experts who review the wine. Typically, a winery/vintner will join or subscribe to the service that generates the wine graphs, to have its wines reviewed. As noted at step 150, the winery will submit samples of its wines to be reviewed which are distributed to a panel of experts (step 160). At step 170, the wines are reviewed by the experts with each expert tasting the wine and scoring it on each of the twelve criteria. Preferably, the panel includes three experts.

Each expert provides his or her scores to the expert responsible for the tasting session who will finally enter values into the inventive system through the Web-based GUI. The scores range from 1-5 and correspond to the strength zones on the graph. The expert scores are then averaged and the software creates a wine graph from the average of the individual scores (steps 180, 190). The wine graph is then electronically associated with the wine and saved into the database for future use (step 200).

Preferably, a winery can only submit a wine once per year or vintage. If a winery wants to resubmit a wine, it will have to provide it at their cost. It is anticipated, however, that as a wine evolves over time it will be reevaluated to provide a representative wine graph.

Another important aspect of the present invention is the versatility of the inventive graphs. Indeed, the wine graphs 50 may be utilized in numerous ways. Wineries who have graphs 50 stored in the database, can access them through the Internet and print them or store them to disk as, for example, a .pdf or .gif file. The graphs 50 can then be incorporated into marketing materials, such as catalogs, guides and like publications, or can be included on the wine's label either directly into the label or added to existing labels or bottles as a sticker.

As should be apparent, the inclusion of wine graphs 50 on a label may be highly desirable for European wines typically categorized by geographic region. Such inclusion could potentially increase sales in non-European markets such as the United States as the intuitive graphs 50 transcend potential language issues and similar impediments to the purchase of such wines.

Importantly, the graphs 50 can also be incorporated into point of sale materials that can be displayed next to a wine on a retailer's shelves. Likewise, retailers such as liquor stores, wine shops and supermarkets, can potentially access wine graphs 50 such that they can deploy them at their retail locations to increase sales. The graphs 50 may be displayed on a shelf in close proximity to a bottle or even hung around a bottle neck. Wine graphs 50 may also be printed with relief inks to make textured wine labels that are accessible to sight impaired individuals.

The inventive system also contemplates consumers searching for wine graphs by accessing the system through the Internet. Preferably, though a GUI, consumers can search by multiple criteria, including by name, vintage and geographic region. Searches can also be conducted based on the twelve criteria used to evaluate the wines or on the four general criteria groups mentioned above, such as, for example, aging potential. Wine graphs may also be printed by consumers or saved to personalized accounts in the database.

Moreover, the present system allows retailers and vintners to create wine graphs of consumer preferences or habits. These wine graphs, typically scores that have averaged from compiled individual consumer preferences, can be based on criteria such as country, region, gender, etc. For example, a retailer could create a graph depicting the characteristics of white wine preferred by women in the United States. This graph could be used to assist the retailer in stocking his or her store to match the aforementioned characteristics. The graphs could also be used by a vintner in determine the characteristics of wine to be produced in the future.

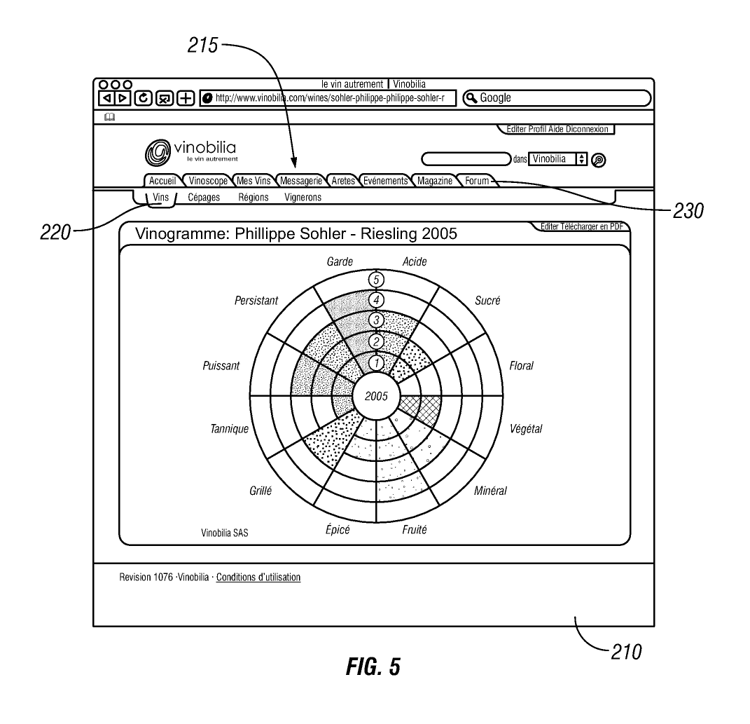

FIG. 5 is a screen capture of an exemplary GUI 210. The capture depicts a tabbed interface 215, which includes tabs for searching 220 by, inter alia, wines and regions and for user forums 230, among other selections. The GUI also depicts an inventive wine graph 50 for, in this example, a 2005 Riesling.

The inventive system also allows consumers to generate graphs that reflect their personal preferences. Consumers can compare their personalized preference graphs to existing wine graphs to quickly determine whether a wine meets the consumer's needs. This comparison may be done electronically by the inventive system with wines that match the consumer's preference profile being compiled and presented to the consumer through the GUI. Consumers may also electronically compare their personalized graphs to other graphs of consumer's who have subscribed to the inventive system and have personalized graphs stored in the database.

Preferably, the personalized preference graphs are printed on a transparent card containing preference graphs for each wine type, e.g., red, white, rose, dessert wines, and champagne. The cards are transparent so that they may be superimposed over, for example, point of sale wine graphs to easily determine if a wine meets the consumer's preferences regardless of the language used on the bottle label and consumer's language.

Consumers may create personalized graphs through several methods, e.g, though an organized wine tasting of system subscribers or members, through a tasting kit, or through reviews of specific wines that are stored in consumer accounts in the system database.

With organized tasting, system subscribers will be presented with several wines to taste and evaluate based on the twelve criteria. Preferences as to the criteria, will be logged in a form either electronically through the system via the Internet or on paper to be entered electronically at a later time. Once logged and entered, preferences can be set, and graphs generated, for different wine types, i.e., red, white, rose, etc. It is also possible for system subscribers to receive a tasting kit upon joining the system. This kit would gather preference data in a manner similar to that of an organized tasting though the data collection would ideally be through the Internet at the time of the tasting.

Finally, preference graphs can be created from reviews of wines that are stored in the system database. For example, the system may allow consumers to enter information on wines they have tasted. If the wines are in the database, and the consumer indicates whether he or she liked the wine, then personal preferences can be easily linked to wine graphs to create a personalized graph. As will be appreciated, other consumer data may be extracted and processed to create a graph should the reviewed wine not have an existing wine graph.

The inventive system provides for the compilation and use of consumer data. By way of example, the system may utilize consumer data to provide suggestions as to new wines that match a consumer's preference graph. Also, consumer data may be compiled to show trends in wine buying and consumption which could be utilized by retailers or wineries as a marketing tool.

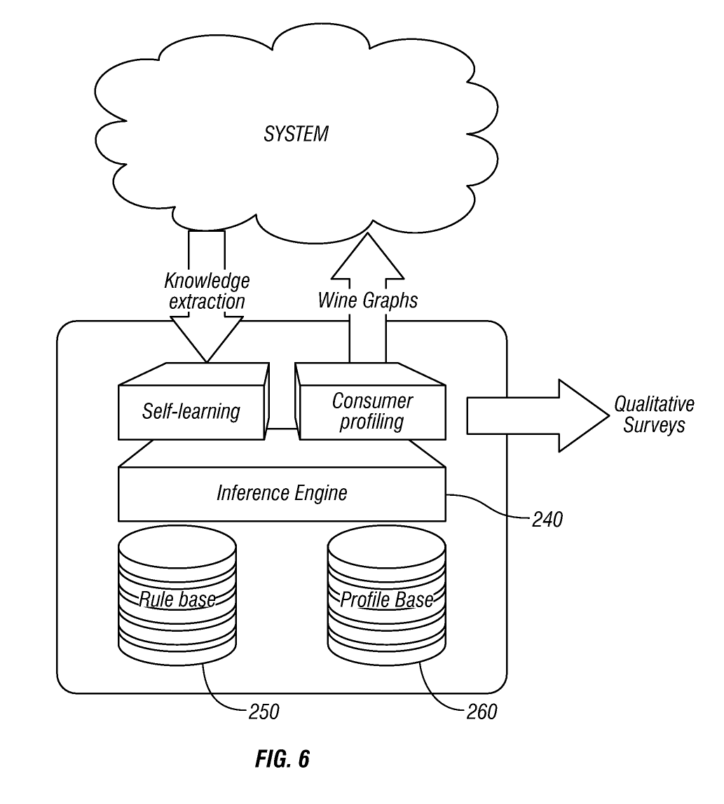

As shown in FIG. 6, the inventive system may also include an expert system 240 which can be employed to create qualitative surveys from a machine readable knowledge base, i.e., a database, which in the present system is a rule base 250, containing rules applicable to the data, and a profile base 260 containing data regarding characteristics of consumers. The expert system 240 preferably provides inferences regarding the stored data. As will be appreciated, other suitable modeling languages may be employed.

The present invention could employ the expert system 240 in several contexts. The expert system could be used in connection with users' wine lists in which consumers manage their wines, a journal where users share wine experiences, a winery database, and/or wine, varietal and appellation databases.

Similarly, the expert system 240 can be used in numerous ways. For example, the system can provide suggestions for new wines to users based on their personal information including their personal graph data. The expert system 240 may also provide wine recommendations based on specific foods. Additionally, the system may provide information for market surveys such as geographic data analysis. If wine is sold on the site, the expert system 240 can provide information regarding which wines and users may match. As will be appreciated, other rules and analysis may be utilized.

The expert system is an important aspect of the present invention as it provides a way of quickly and efficiently obtaining valuable marketing analyses regarding consumer preferences. The expert system is also significant as it allows users to generate data that can be used to make highly informed purchases and fosters a greater general understanding of wine.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

I claim:

1. A graphic indicator of olfactory and gustatory characteristics of a beverage, said indicator comprising:
a background portion, said background portion being a first color;
a plurality of contiguous segments on said background portion, each segment representing a separate characteristic of said beverage, and each segment being divided into separate strength zones; and
wherein each of said strength zones can be darkened in a color other than said first color to indicate a strength level of a characteristic of said beverage to provide a graphic representation of said beverage to enable consumers to make an informed purchasing decision.

2. The graphic indicator of claim 1 wherein each segment has a color that is different from said background color and different from colors of adjacent segments.

3. The graphic indicator of claim 1 wherein said characteristics are gustatory and olfactory properties of a wine.

4. The graphic indicator of claim 3 wherein said characteristics further include aging potential of said wine.

5. The graphic indicator of claim 1 wherein said background portion is substantially round and includes a center portion containing information identifying said wine.

6. The graphic indicator of claim 4 wherein said characteristics are grouped into taste, aroma, structure and aging potential.

7. The graphic indicator of claim 6 wherein said taste group comprises the characteristics acidity and sweetness.

8. The graphic indicator of claim 6 wherein said aroma group comprises the characteristics floral, vegetal, mineral, fruity, spicy and toasty.

9. The graphic indicator of claim 6 wherein said structure group comprises the characteristics tannic, powerful and persistent.

10. The graphic indicator of claim 1 wherein said indicator includes five strength zones per characteristic.

11. A method of creating a graphic indicator of gustatory and olfactory characteristics of a beverage comprising the steps of:
obtaining a sample of said beverage;
tasting said beverage;
scoring said beverage on criteria representative of said gustatory and olfactory characteristics; and
creating a graphic indicator from said scores representative of said gustatory and olfactory characteristics of said beverage.

12. The method of claim 11 further comprising the step of:
providing samples said beverage to a plurality of experts to taste and score.

13. The method of claim 12 further comprising the step of:
obtaining an averaged score from said scores of said plurality of experts.

14. The method of claim 13 wherein said graphic indicator is created from said averaged score.

15. The method of claim 11 wherein said beverage is wine.

16. The method of claim 11 further comprising the step of:
storing said graphic indicator in a database.

17. The method of claim 16 further wherein said database is accessible via the Internet.

18. A system for the creation and dissemination of graphic indicators of olfactory and gustatory characteristics of wine:
a processor, said processor generating graphic indicators of said characteristics;
a database operatively connected to said processor said database storing said graphic indicators; and
wherein said processor and said database are electronically accessible to locate and retrieve said graphic indicators.

19. The system of claim 18 wherein said system further comprises a means for inputting data representative of said characteristics, said means being operatively connected to said processor.

20. The system of claim 19 wherein said data input means can receive data representative of consumer preferences and identifying information which may be stored in said database.

21. The system of claim 20 further comprising an expert system for analyzing said wine characteristics, consumer preferences and identifying information.

22. A tactile indicator of olfactory and gustatory characteristics of a beverage, said indicator comprising:
a background portion, said background portion being a first texture;
a plurality of contiguous segments on said background portion, each segment representing a separate characteristic of said beverage, and each segment being divided into separate strength zones; and
wherein each of said strength zones can be textured in a texture other than said first texture to indicate a strength level of a characteristic of said beverage to provide a tactile representation of said beverage to enable sight-impaired consumers to make an informed purchasing decision.
